(19) United States
(12) Patent Application Publication
(10) Pub. No.: US 2008/0101469 A1
(43) Pub. Date: May 1, 2008

(54) METHOD AND APPARATUS FOR ADAPTIVE NOISE FILTERING OF PIXEL DATA

(75) Inventors: FAISAL ISHTIAQ, CHICAGO, IL (US); RAGHAVAN SUBRAMANIYAN, BANGALORE (IN)

Correspondence Address: MOTOROLA, INC., 1303 EAST ALGONQUIN ROAD, IL01/3RD, SCHAUMBURG, IL, 60196, US

(73) Assignee: MOTOROLA, INC., SCHAUMBURG, IL (US)

(21) Appl. No.: 11/554,807

(22) Filed: Oct. 31, 2006

(51) Int. Cl. H04N 11/02

(52) U.S. Cl. 375/240.13; 375/240.12; 375/240.16

(57) ABSTRACT

A method and apparatus for processing frames of pixel data is provided. The apparatus can be a video encoder and includes an interface receiving a current frame including a plurality of blocks of pixel data. The apparatus further includes a processing device coupled to the interface, with the processing device: determining a filter parameter setting for each of the plurality of blocks of the current frame based on encoding parameters of the current frame and based on motion characteristics derived using a previous reconstructed frame; and filtering each of the plurality of blocks based on the filter parameter setting to use in generating a filtered output with mitigated noise.

### TECHNICAL FIELD

This invention relates generally to the filtering of noise from pixel data such as video data.

### BACKGROUND

Digital image compression, e.g., digital video compression, is used primarily to reduce the data rate of a source video by generating an efficient, non-redundant representation of the original source video. Efficient video coding techniques such as International Telecommunication Union-Telecommunications (“ITU-T”) (H.261, H.263, H.264), International Standards Organization/International Engineering Consortium (“ISO/IEC”) Moving Picture Experts Group-1 (“MPEG-1”), MPEG-2, and MPEG-4 standards capitalize on redundancies that exist within frames of the source video and among consecutive frames to achieve high compression ratios. Noise in a video system is a disruptive phenomenon that adds uncertainty to the source pixels. It is both visually displeasing and reduces the redundancies within the source video. When coded, the random pixel fluctuations result in poorer compression performance that adds to the distortions. It is therefore important for a video coding system to mitigate noise to improve the coding efficiency with fewer distortions.

The entropy of a source video sequence defines the lowest compression ratio beyond which distortions will occur. Within the video coding standards, these distortions are in the form of loss in both temporal and spatial fidelity. Tolerance of these artifacts is key to achieving the compression rates required for delivery via the different video transmission mediums. Noise within the source data increases the entropy of the source and therefore increases the threshold below which distortions will occur. Thus, for the same compression ratio, a noisy sequence exhibits more distortions. Loss in compression is undesired and the resulting visual distortions can be highly distracting.

Within a video system, a common place for noise to occur is during the frame capture phase within the sensor. It is common for a low quality image sensor to output an image with noise. If the sensor is capturing data in interlaced format (which uses two interlaced fields per frame), the interlacing process typically adds to the noise as a result of these two fields being slightly shifted in time. Higher quality image sensors result in less noisy images but they are not completely noise free.

Noisy source video sequences exhibit random pixel variations that are sometimes referred to as “mosquito noise”, or the frame is described as being “busy.” These variations are due to the same pixel locations exhibiting small intensity and color fluctuations from frame to frame. Video coding systems attempt to mitigate noise by a variety of techniques. Some techniques include pre-processing the source video frames to reduce the amount of noise. Other techniques include post-processing the compressed video to mitigate the effects of the noise. Additional techniques include filtering the source data within the encoding loop either as an in-loop filter (as mandated by the standards), or as an extra filter (outside the scope of the standards) not replicated within the decoder.

Typical pre-processing techniques utilize spatial filters such as median and low-pass filtering and temporal filtering such as temporal Infinite Impulse Response (“IIR”) filters. Spatial filtering during the pre-processing can add a large amount of complexity and disrupt the imaging capture and presentation pipeline. Furthermore, spatial filtering does not always address the temporal characteristics of the noise. Temporal filtering typically requires complexity that may have to be implemented outside of the sensor and can disrupt the timing and imaging pipeline, and, at a minimum, the previous source frame must be buffered for filtering of the current pixel. On low complexity encoding scenarios, this is often not an option.

Post-processing techniques are well known and employed for various purposes. The post-processing techniques for handling distortion due to noise include deblocking, restoration, and mosquito filters. These techniques all add complexity to the decoding process and can be independent of the encoder. A great drawback of the post-processing techniques is that the post-processor works on an after-the-fact basis with respect to the noise. The encoder has compressed the noisy frame inefficiently and the post-processor attempts to visually mask out the displeasing output. The complexity burden is shifted to the decoder to address noise that the encoder could not handle or mitigate.

What is needed is an improved method and apparatus for image processing, which filters a source image to mitigate noise in the image prior to image compression and encoding, and which does not require the implementation complexities required in prior art techniques. It is further desired that the improved method an apparatus for image processing adapts to the local nature of the encoding process.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates a video system according to at least one embodiment of the invention.

FIG. 2 illustrates a flow diagram of a method for video processing in accordance with an embodiment of the present invention.

FIG. 3 illustrates an expanded video system according to at least one embodiment of the present invention.

FIG. 4 illustrates a flowchart of the decision-making process for determining filter strength according to at least one embodiment of the present invention.

FIG. 5 illustrates an original video image.

FIG. 6 illustrates a difference image between two consecutive frames.

FIG. 7 illustrates a difference image after processing with an encoder modified with a temporal filter according to at least one embodiment of the present invention.

### DETAILED DESCRIPTION

Before describing in detail embodiments that are in accordance with the present invention, it should be observed that the embodiments reside primarily in combinations of method steps and apparatus components related to a method and apparatus for adaptive noise filtering of pixel data. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

It will be appreciated that embodiments of the invention described herein may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and apparatus for adaptive noise filtering of pixel data described herein. The non-processor circuits may include, but are not limited to, video cameras. As such, these functions may be interpreted as steps of a method to perform the adaptive noise filtering of pixel data described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Both the state machine and ASIC are considered herein as a “processing device” for purposes of the foregoing discussion and claim language.

Moreover, an embodiment of the present invention can be implemented as a computer-readable storage element having computer readable code stored thereon for programming a computer (e.g., comprising a processing device) to perform a method as described and claimed herein. Examples of such computer-readable storage elements include, but are not limited to, a hard disk, a CD-ROM, an optical storage device and a magnetic storage device. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Generally speaking, pursuant to the various embodiments, the present invention is directed to a method and system for utilizing a temporal IIR filter to reduce noise in a source image, such as a video image. The method described below overcomes the shortcomings of previous methods and systems by using a temporal IIR filter whose strength adapts to the local nature of the encoding of the source image. The filter strength is configured for each macroblock or pixel region of an image. The IIR nature of the filter requires knowledge about only the previously reconstructed frame. This is in contrast with the need for multiple past or future frames for the FIR filters that have been used previously. Motion is estimated between a previously reconstructed frame and the current image frame. An amount by which this motion is to be compensated is determined and is utilized in filtering the current source image.

The teachings described below carry out low-complexity filtering of video sequencing that are badly degraded by noise to improve compression efficiency. The filtering of the source image data is carried out in an encoder loop to, for example, reduce the effect of camera sensor noise.

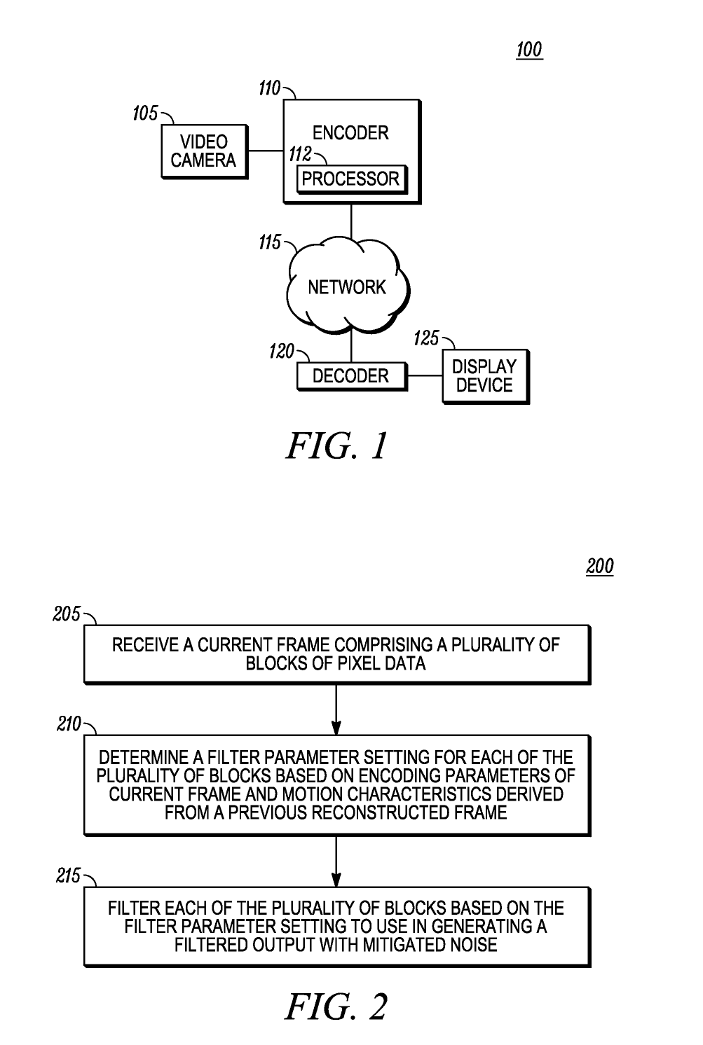

FIG. 1 illustrates an exemplary video system 100 according to at least one embodiment of the invention. As shown, the video system 100 includes a video camera 105 or other video source device such as a storage device having pre-stored video image data, an encoder 110, a network 115, a decoder 120, and a display device 125. The video camera 105 captures video images and generates the source video. The source video is output to the encoder 110 via any suitable interface including a wireless (e.g., radio frequency) or wired (e.g., USB) interface, which encodes the source video into a format suitable for transmission across the network 115 or for reception via any other suitable “channel” such as a storage device. The encoder 110 includes a processor 112 and can be physically co-located within the housing of the camera 105 or implemented as a standalone device. After being transmitted across the network 115, the encoded video is decoded by a decoder 120. Finally, the decoded video is displayed on the display device 125. The display device 125 may comprise, for example, a video monitor or television. The encoder 110 includes a filter in accordance with the teachings herein for reducing the noise in the source video, as described below with respect to the remaining figures.

FIG. 2 illustrates a flow diagram of a method 200, according to at least one embodiment of the invention, which is implemented in encoder 110. Method 200, in general, comprises the steps of: receiving (205) a current frame (of video) comprising a plurality of blocks of pixel data; determining (210) a filter parameter setting for each of the plurality of blocks of the current frame based on encoding parameters of the current frame and based on motion characteristics derived using a previous reconstructed frame; and filtering (215) each of the plurality of blocks based on the filter parameter setting to use in generating a filtered output with mitigated noise. A detailed exemplary implementation of this process will next be described by reference to the remaining figures.

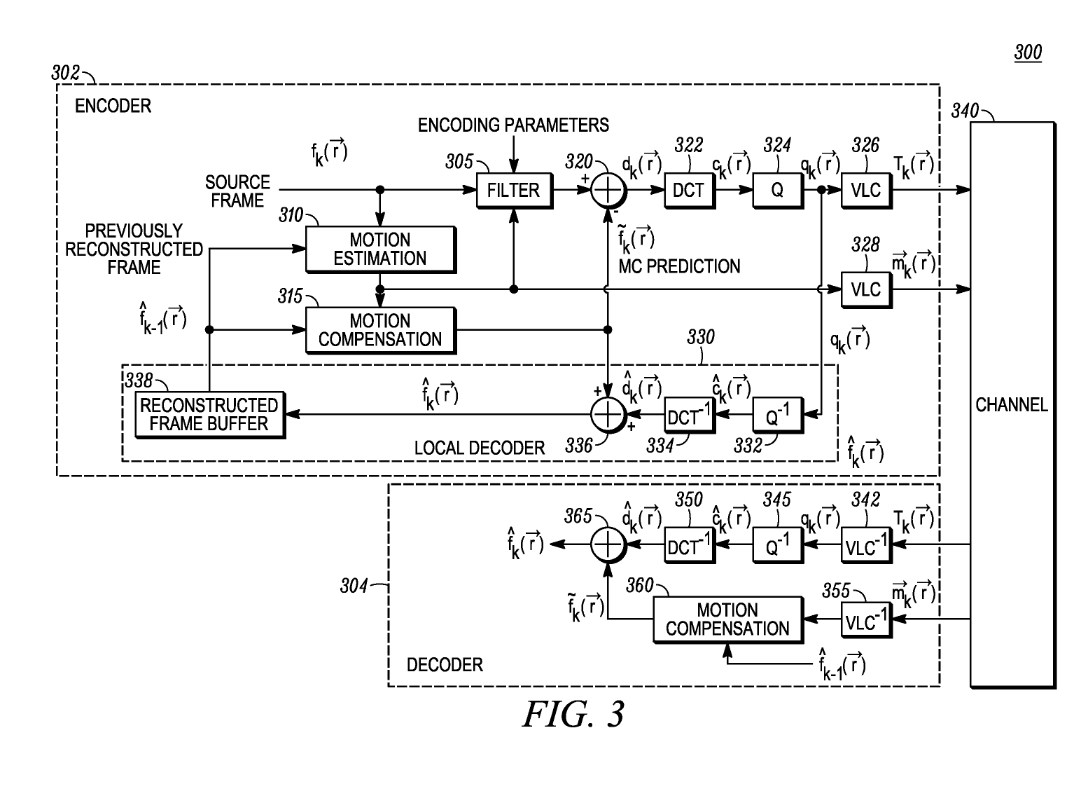

FIG. 3 illustrates an exemplary expanded video system 300 according to at least one embodiment of the invention. As shown, the expanded video system 300 includes an encoder 302 and a decoder 304, with media being transferred from the encoder 302 to the decoder 304 via a channel 340. In the expanded video system 300, a series of source frames are received from a video source (step 205), encoded, transmitted, received, and then decoded. The source frames are denoted as fₖ(\vec{r}), for a set of k ordered frames of video. After the frames are encoded and transmitted, they are decoded and reconstructed remotely. The reconstructed frames are denoted as \hat{f}ₖ(\vec{r}), for the set of k ordered reconstructed frames of video.

As shown, the source frame fₖ(\vec{r}) is sent to a motion-compensated temporal filter 305 (step 205), which is configured in accordance with embodiments of the present invention. Filter 305 determines a filter parameter setting (step 210) based on one or more encoding parameters associated with the current frame and based on one or more motion characteristics derived using one or more previous reconstructed frames, with one previous reconstructed frame being used in the described embodiment. The encoding parameters in this implementation include a coding method (e.g., inter-coding or intra-coding) and a quantization (“Q”) parameter used for the current frame, although other encoding parameters can be used such as, for instance, the coding bitrate and frame intensity variation, as depends on the particular implementation. Filter 305 further filters the source frame (step 215) using the filter parameter setting for use in generating a filtered output, for example the output that is received by or into channel 340.

The source frame fₖ(\vec{r}) is also sent to a motion estimation module 310. The motion estimation module 310 has a function of estimating the motion of a block of pixel data of a current source frame fₖ(\vec{r}) based on data from the previous reconstructed frame \hat{f}ₖ₋₁(\vec{r}). Module 310 can perform its functionality using any suitable function or algorithm, many of which are well known in the art.

Module 310, in this embodiment, provides two motion characteristics to filter 305 to use in adjusting the filter parameter setting. One such motion characteristic is a set of motion vectors, wherein each motion vector represents the motion between a block of pixel data in the current source frame and the corresponding same block of pixel data in the previous reconstructed frame. Each block of pixel data includes at least one pixel (which in this context is the smallest sample of a frame that can be assigned various parameters including, but not limited to intensity, direction, motion, etc.) but usually includes a plurality of pixels such as in the case of a macroblock comprising a 16×16 block of pixels. Moreover, depending on the particular implementation, one or more motion vectors can be provided corresponding to each block in the frames or a motion vector can be provided for some blocks in the frames but not others.

The second motion characteristic that module 310 provides to filter 305 is a distortion metric that represents how well the resulting motion vector for the block of pixel data represents the motion between the source and reference frame. In this embodiment, the distortion metric provided is the SAD (Sum of Absolute Differences), but the teachings herein are not limited to the use of the SAD metric. Other distortion metrics can be used such as, for example, Maximum Difference, Mean of Sum of Absolute Differences, Mean of Absolute Differences, to name a few. However, where a different distortion metric is used, the thresholds used by the filter 305 in determining the filter parameter setting (such thresholds being described in detail below) are correspondingly adjusted.

A motion compensation module 315 receives the previous reconstructed frame \hat{f}ₖ₋₁(\vec{r}) and at least a portion of the motion vectors output from the motion estimation module 310 to generate a motion-compensated (MC) predicted frame, denoted \tilde{f}ₖ(\vec{r}). As with module 310, module 315 can use any suitable function or algorithm for generating its output, many of which are well known in the art. The MC predicted frame \tilde{f}ₖ(\vec{r}) output of the motion compensation module 315 is subtracted from the filtered current frame output of filter 305 by a first summing element 320 to generate a filtered vector, denoted dₖ(\vec{r}) and also referred to herein as a displaced frame difference (DFD) vector.

The filtered vector dₖ(\vec{r}) is output to a Discrete Cosine Transform (“DCT”) block 322. The DCT block 322 performs a Discrete Cosine Transform on 8×8 blocks of pixel data to generate transformed coefficients cₖ(\vec{r}). The 8×8 block size is described for illustrative purposes, and it should be appreciated that other block sizes may alternatively be used. These coefficients are input to a quantization block 324 that quantizes the coefficients according to a quantization (“Q”) parameter to generate qₖ(\vec{r}). The quantized coefficients are encoded by a first variable length code (“VLC”) block 326 to generate an output encoded vector Tₖ(\vec{r}). The output of the motion estimation module 310 is further output to a second VLC block 328 that encodes at least a portion of the motion vectors output of the motion estimation module 310 as a VLC, to generate encoded vectors, mₖ(\vec{r}).

The output from the quantization block 324 and the motion compensation module 315 are further processed by a local decoder 330 to generate locally reconstructed frames. Accordingly, the output of quantization block 324 is initially processed by an inverse quantization block 332 to generate dequantized coefficients ĉₖ(\vec{r}). The dequantized coefficients ĉₖ(\vec{r}) are processed by a first inverse DCT block 334 to generate vector \hat{d}ₖ(\vec{r}). Vector \hat{d}ₖ(\vec{r}) is added by a second summing element 336 to the output from the motion compensation module 315, \tilde{f}ₖ(\vec{r}), to generate a locally reconstructed frame \hat{f}ₖ(\vec{r}). Locally reconstructed frame \hat{f}ₖ(\vec{r}) is stored in a local reconstructed frame buffer 338. The local decoder 330 is utilized to supply the previous reconstructed frames \hat{f}ₖ₋₁(\vec{r}) to the motion estimation module 310 and the motion compensation module 315 for the process 200.

Output vectors Tₖ(\vec{r}) and mₖ(\vec{r}) are output or sent to a channel 340. The channel 340 may be utilized, for example, as a storage medium such as a hard disk drive, CD-ROM, and the like. The channel 340 may, alternatively, be utilized as a transmission channel to transport output vectors Tₖ(\vec{r}) and mₖ(\vec{r}) across the network 115 shown in FIG. 1. Output vectors Tₖ(\vec{r}) and mₖ(\vec{r}) are received by the decoder 304 via the channel 440. Vector Tₖ(\vec{r}) is sent to a first inverse VLC block 342 that removes the VLC encoding from the vector Tₖ(\vec{r}) to generate qₖ(\vec{r}), and then to an inverse quantization block 345 that has a function of dequantizing the input quantized coefficients. The output from the inverse quantization block 345, ĉₖ(\vec{r}), is sent to an inverse DCT block 350, which performs an inversion of the DCT to reconstruct vector \hat{d}ₖ(\vec{r}).

Vector mₖ(\vec{r}) is sent from the channel 340 to a second inverse VLC block 355 that performs an inverse VLC function to recover the original unencoded output from the motion estimation module 310 of the encoder 302. This vector is sent to a motion compensation module 360 that also receives the previously reconstructed frame, \hat{f}ₖ₋₁(\vec{r}) and outputs a motion compensation vector \tilde{f}ₖ(\vec{r}). Finally, the vectors \hat{d}ₖ(\vec{r}) and \tilde{f}ₖ(\vec{r}) are summed by a second summing element 365 to generate reconstructed frame \hat{f}ₖ(\vec{r}).

The video system 300 shown in FIG. 3 utilizes a generic hybrid motion compensated-DCT based technique that is the basis for most of the standards-based video encoding techniques. Unlike the typical systems, however, this video system 300 also incorporates the additional filter 305 before the displaced frame difference is computed. This filter 305 is an adaptive temporal IIR filter that filters the current frame with respect to the encoding parameters used for the current frame and motion characteristics derived from one (or more if desired) previous reconstructed frames. For example, xₜ(n) may be the value of a pixel in the current source frame and ŷₜ₋₁(n) be the value of the same pixel in the previous reconstructed frame based on motion estimation. The filter 305 disclosed above uses ŷₜ₋₁(n) and x₁(n) to produce the noise reduced source pixel \hat{x}ₜ(n), which is defined as:

$${\hat{x}}_{t} ( n ) = {\hat{y}}_{t - 1} ( n ) + ( {x}_{t} ( n ) - {\hat{y}}_{t - 1} ( n ) ) [ 1 - {e}^{- ( {( \frac{\vert {x}_{t} ( n ) - {\hat{y}}_{t - 1} ( n ) \vert}{AT} )}^{AG} )} ] .$$

The parameters AT and AG in the filter equation are filter strength parameters that are adapted to the nature of the source video, with the value of these parameters being determined based on the encoding parameters for the current frame and the motion characteristics derived using the previous reconstructed frame, for example, as described below. As defined, the filter 305 can be used within the encoder 302 without it needing its operation to be matched in the decoder 304. This allows the filter 305 to be independent of the particular video coding standard being used.

In an exemplary embodiment, the filter strength adapts on a macroblock basis between three levels of filtering—no filter, normal filter, and strong filter. All pixels within a particular macroblock are filtered with the same strength. The filter setting for each of the levels is: (a) No Filtering; (b) Normal Filtering→AT=5 and AG=0.9; and (c) Strong Filtering→AT=30 and AG=0.9, such values being usually based on empirical data. More or fewer levels can be used in alternative embodiments and the levels can be discrete or continuous. The filter strength is computed for each macroblock within a frame, as discussed above.

The decision process for filtering a macroblock is based upon (a) the coding method (INTRA corresponding to intra-coding or INTER corresponding to inter-coding) for the macroblock, (b) the quantization parameter (Q), (c) absolute motion vector magnitude (“MV”), (d) the SAD provided by the motion estimation, and (e) the appropriate thresholds for each of these criteria. By one approach, the absolute motion vector value is the sum of the individual absolute x and y motion vector components, written as:

MV=|MVₓ+|MV_{y}|.

The decision mechanism in the exemplary embodiment is shown in Table A below with the appropriate thresholds. Within each filter strength column if any of the conditions is satisfied that level is selected. The order of logic begins with the No Filter logic and proceeds towards the Strong Filter logic checks. As such, the No Filter logic is the first logic tested.

There are thresholds for each of the Q, MV, and SAD parameters. The Q thresholds are Q1, Q2, and Q3 with the criteria that Q1<Q2<Q3. The MV criteria has two MV thresholds, MV1 and MV2 with the restriction that MV1<MV2. Finally, there is only one SAD threshold, SAD1. In the exemplary embodiment the thresholds are: (a) Q1=3; (b) Q2=6; (c) Q3=12; (d) MV1=0.5; (e) MV2=1.0; and (f) SAD1=5000.

TABLE A

| No Filter | Normal Filter | Strong Filter |
|---|---|---|
| INTRA MB | Q₁ < Q ≦ Q₂ | Q₂ < Q ≦ Q₃ |
| Q ≦ Q₁ | MV1 < MV ≦ MV2 | MV ≦ MV1 |
| Q > Q₃ | | |
| MV > MV2 | | |
| SAD > SAD1 | | |
| No filter is applied if | A normal filter is | A strong filter is applied |
| encoding the fidelity is | applied in the | when the fidelity is not |
| either too high or too | moderate ranges of | too high or when there is |
| low, or if the motion is | both quality and | little motion between the |
| too high, which would | motion. | two frames. |
| cause “bleeding.” | | |

Q₁ = 3
Q₂ = 6
Q₃ = 12
MV1 = 0.5
MV2 = 1.0
SAD1 = 5000

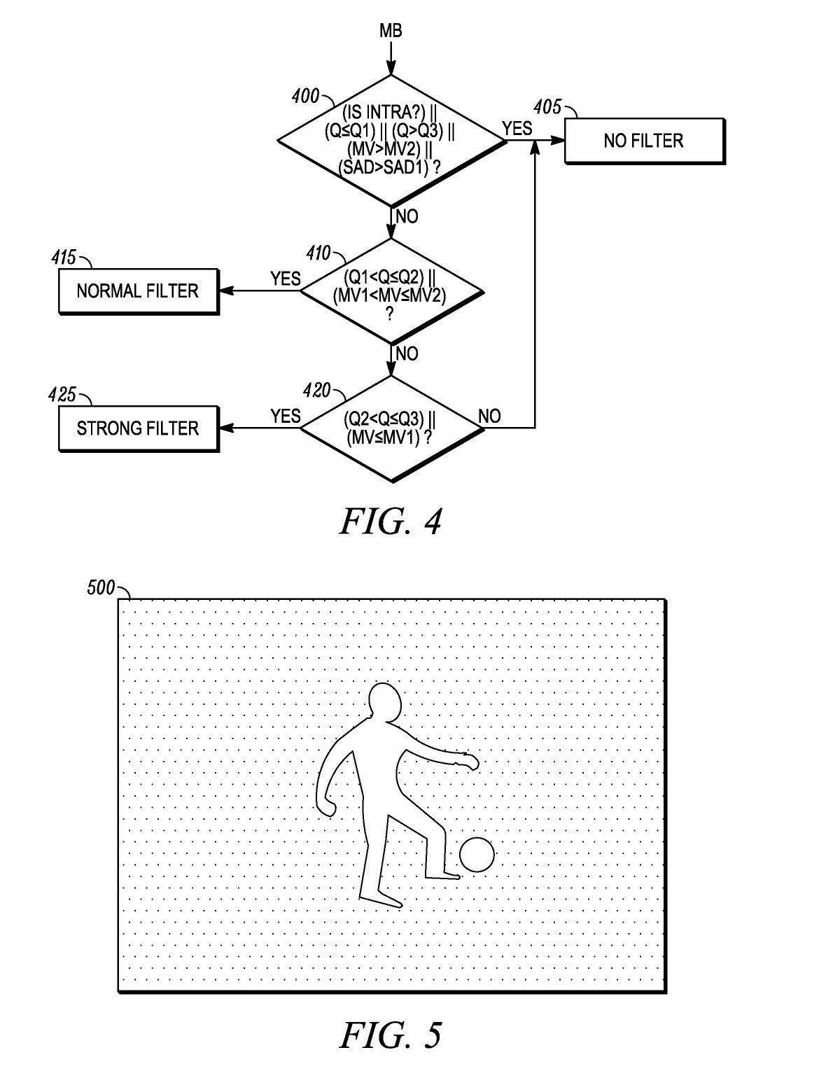

FIG. 4 illustrates a flowchart of the decision-making process discussed above. A macroblock is received and the filtering strength decision is made based upon characteristics in the macroblock. In some cases, blocks smaller than macroblocks may alternatively be analyzed. First, at operation 400, a determination is made as to whether the macroblock is (a) INTRA coded, (b) Q≦Q1, (c) Q>Q3, (d) MV>MV2, or (e) SAD>SAD1. If any of these conditions is satisfied, processing proceeds to operation 405 and the filter setting is set to “No Filter.” If none of these conditions is satisfied, processing proceeds to operation 410, where a determination is made regarding whether (a) Q1<Q<Q2, or (b) MV1<MV≦MV2. If either of these conditions is satisfied, processing proceeds to operation 415 and the filter setting is set to “Normal Filter.” If none of these conditions is satisfied, processing proceeds to operation 420, where a determination is made regarding whether (a) Q2<Q≦Q3, or (b) MV≦MV1. If either of these conditions is satisfied, processing proceeds to operation 425 and the filter setting is set to “Strong Filter.” If, however, none of these conditions are satisfied, processing proceeds to operation 405 and the filter setting is set to “No Filter.”

The filter strength decisions are based upon the characteristics of the encoding and how noise is perceived by the human visual system (“HVS”). Noise is more easily discerned in smooth, non-moving, areas of a frame than in highly textured and moving areas. The teachings discussed herein encompass this attribute of the HVS by including the motion vector information in the strength decision mechanism. The fidelity of the coded macroblock also plays an important role in the perception of noise. A high Q results in less coding fidelity and as such the addition of noise will not significantly degrade the quality any further. A low Q will result in better fidelity that typically indicates that noise is limited and not needing of filtering. The teachings discussed herein address this aspect with the inclusion of the Q in the decision mechanism. As shown in an embodiment discussed above, INTRA macroblocks are not filtered. This is to preserve the independent nature of the INTRA macroblocks for error resilience purposes. Since INTRA macroblocks occur with less frequency than INTER macroblocks, not filtering them does not significantly impact the perceived quality.

The filter 305 discussed above may be easily implemented in the form of a look-up table. This significantly reduces the computational complexity of the filter 305, as the exponents do not have to be computed in real-time.

It is seen from the filter equation that for bounded ŷₜ₋₁(n) and xₜ(n) values, the addend

$${\hat{x}}_{t} ( n ) = {\hat{y}}_{t - 1} ( n ) + ( {x}_{t} ( n ) - {\hat{y}}_{t - 1} ( n ) ) [ 1 - {e}^{- ( {( \frac{\vert {x}_{t} ( n ) - {\hat{y}}_{t - 1} ( n ) \vert}{AT} )}^{AG} )} ]$$

can be pre-computed for all difference values and stored in a table that is indexed by the difference between ŷₜ₋₁(n) and xₜ(n). This results in an efficient implementation of the embodiment.

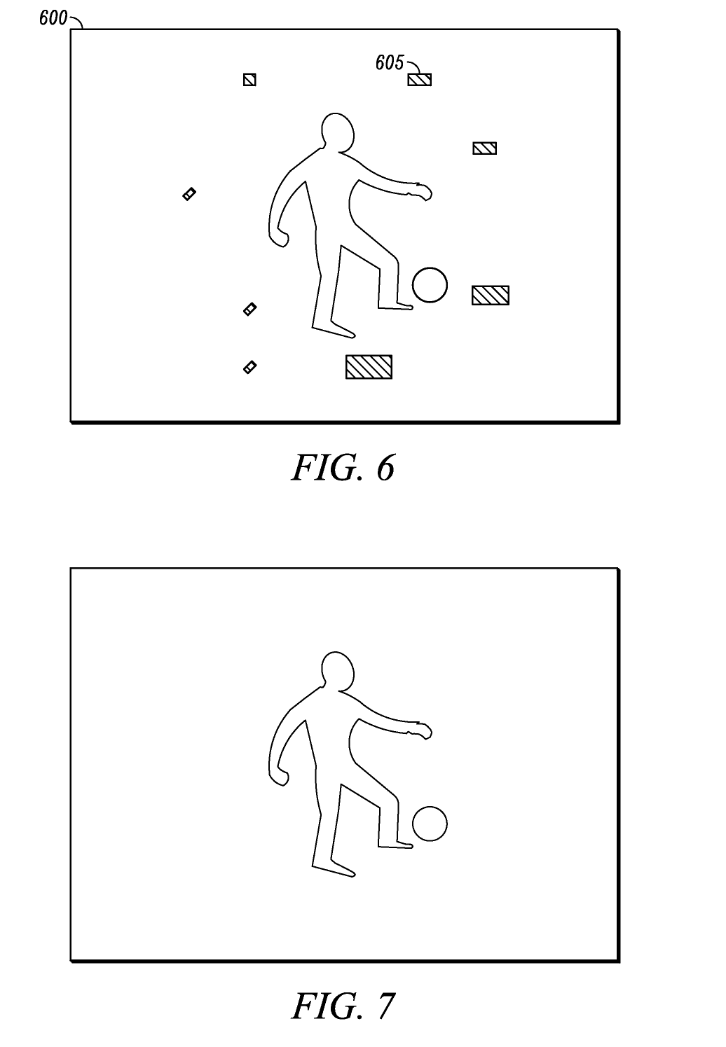

FIG. 5 illustrates an original video image 500 according to at least one embodiment of the invention. Simply passing this noisy source frame into a typical video encoder would result in non-stationary blocking shown in the difference image 600 of FIG. 6. In FIG. 6, the difference between two consecutive frames is shown. As shown, noise variations cause blocks that have no movement to differ from one frame to the next. This is manifested in the encoded video as movement in the regions where there is no movement. For example, area 605 shows movement even though the objects in the image were not moving from one frame to the next. Instead, this undesirable area was produced as a result of noise.

Passing the same video into an encoder modified with the temporal filter 305 of FIG. 3 results in a much more stationary video as shown in the difference image 700 of FIG. 7. As shown, the noise of original image 500 of FIG. 5 has been effectively mitigated in the resultant difference image 700 of FIG. 7. Subjectively, the output video also does not exhibit the level of annoying artifacts that the non-filtered video exhibited.

The selective use of the filter 305 allows the complexity to be kept low. As designed, more filtering can be performed in flat regions and in sequence segments with low activity. This matches the characteristics of the HVS that distinguishes distortions in flat regions much more than in regions with high texture and/or motion. As such, less filtering can be performed in high-motion regions. This behavior complements the behavior of a video encoder where the complexity is typically higher in high motion areas. Therefore, the peak complexity is largely unaffected.

In terms of metrics, the subtle analytical, yet visually pronounced, nature of the noise induced blocking does not get captured by the Peak signal-to-noise ratio (“PSNR”) distortion metric. Thus, a noisy sequence can have a PSNR metric very similar to a sequence completely noise free. However there will be a stark difference between the two when viewed visually. Accordingly, an additional benefit of these teachings is a general reduction in the bitrate of the filtered sequence verses an unfiltered one.

The teachings discussed herein provide a system and method to mitigate noise in coded video. Noise is a natural occurring phenomenon in nearly all camera sensors. It is even more prevalent in surveillance and safety scenarios where atmospheric conditions also contribute random luminance variations at the sensor.

This temporal video filter method is based upon the hybrid motion-compensated DCT-based coding technique and is applicable to all of the standards-based video codecs including MPEG-1, MPEG-2, MPEG-4, H.261, H.263, and H.264. It is an adaptive method that dynamically adjusts the level, or strength, of filtering usually many times within a frame. It may be efficiently implemented in software and requires simple table lookups.

A further exemplary benefit of this method is to efficiently reduce noise in compressed video. This can be due to commonly occurring factors in imaging that include sensor sensitivity and atmospheric conditions. These teachings provide the capability of encoding video data with better visual quality and lower compression rates.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

What is claimed is:

1. A method for processing frames of pixel data comprising the steps of:
receiving a current frame comprising a plurality of blocks of pixel data;
determining a filter parameter setting for each of the plurality of blocks of the current frame based on encoding parameters of the current frame and based on motion characteristics derived using a previous reconstructed frame; and
filtering each of the plurality of blocks based on the filter parameter setting to use in generating a filtered output with mitigated noise.

2. The method of claim 1, wherein the encoding parameters comprise a coding method and a quantization parameter for each of the plurality of blocks.

3. The method of claim 2, wherein the coding method comprises one of inter-coding and intra-coding.

4. The method of claim 1, wherein the motion characteristics comprise an absolute vector magnitude and a distortion metric.

5. The method of claim 4, wherein the distortion metric is a sum of absolute differences (“SAD”) determination resulting from motion estimation.

6. The method of claim 1, wherein the filter parameter setting for each of the plurality of blocks is determined from comparing at least one of the encoding parameters and the motion characteristics to a corresponding threshold value.

7. The method of claim 1, wherein the filter parameter setting is determined based on motion characteristics derived from only one immediately previous reconstructed frame.

8. The method of claim 1, wherein each of the plurality of blocks comprises a macroblock of pixel data.

9. The method of claim 1 further comprising the step of sending the filtered output to at least one of a transmission channel and a storage medium.

10. Apparatus for processing frames of pixel data, comprising:
an interface receiving a current frame comprising a plurality of blocks of pixel data; and
a processing device coupled to the interface, the processing device:
determining a filter parameter setting for each of the plurality of blocks of the current frame based on encoding parameters of the current frame and based on motion characteristics derived using a previous reconstructed frame; and
filtering each of the plurality of blocks based on the filter parameter setting to use in generating a filtered output with mitigated noise.

11. The apparatus of claim 10, wherein the apparatus comprises an encoder.

12. The apparatus of claim 11, wherein the encoder is operated in accordance with a standard of operation including at least one of International Telecommunication Union-Telecommunications (“ITU-T”) H.261, ITU-T H.263, ITU-T H.264, International Standards Organization/International Engineering Consortium (“ISO/IEC”) Moving Picture Experts Group-1 (“MPEG-1”), MPEG-2, and MPEG-4 standards.

13. The apparatus of claim 10 further comprising a source device coupled to the interface and providing the current frame.

14. The apparatus of claim 13, wherein the source device comprises at least one of a camera and a storage device.

15. A computer-readable storage element having computer readable code stored thereon for programming a computer to perform a method for processing frames of pixel data, the method comprising the steps of:
receiving a current frame comprising a plurality of blocks of pixel data;
determining a filter parameter setting for each of the plurality of blocks of the current frame based on encoding parameters of the current frame and based on motion characteristics derived using a previous reconstructed frame; and
filtering each of the plurality of blocks based on the filter parameter setting to use in generating a filtered output with mitigated noise

16. The computer-readable storage medium of claim 15, wherein the computer readable storage medium comprises at least one of a hard disk, a CD-ROM, an optical storage device and a magnetic storage device.
